(19) United States
(12) Patent Application Publication
(10) Pub. No.: US 2014/0327765 A1
(43) Pub. Date: Nov. 6, 2014

(54) CAMERA IMAGE CALIBRATING SYSTEM AND METHOD OF CALIBRATING CAMERA IMAGE

(71) Applicant: Altek Autotronics Corporation, Hsinchu (TW)

(72) Inventors: Ta Hsien, Taichung City (TW); Chen-Hsuan Tai, Hsinchu County (TW)

(21) Appl. No.: 13/912,208

(22) Filed: Jun. 7, 2013

(30) Foreign Application Priority Data
May 3, 2013 (TW) 102115928

(51) Int. Cl. G06T 7/00; G06K 9/00; B60Q 9/00; H04N 17/00

(52) U.S. Cl. CPC G06T 7/0018; H04N 17/002; G06K 9/00798; B60Q 9/008
USPC 348/143

(57) ABSTRACT

A camera image calibrating system applicable to a transportation vehicle including at least one image capturing unit, direction sensing units and a processing unit is provided. The image capturing unit is disposed on the transportation vehicle according to a height to preview an image. The direction sensing units are disposed on the transportation vehicle and the image capturing unit to obtain a vehicle directional angle and an image capturing directional angle. The processing unit calculates an image transformation relationship and causes the image to comply with an image preset condition. The processing unit determines an offset angle of the image capturing unit according to the image, the vehicle directional angle and the image capturing directional angle, and further calculates the image transformation relationship according to the height, the offset angle and the image, in a static calibration procedure. A method of calibrating camera images is also provided.

### CROSS-REFERENCE TO RELATED APPLICATION

This application claims the priority benefit of Taiwan application serial no. 102115928, filed on May 3, 2013. The entirety of the above-mentioned patent application is hereby incorporated by reference herein and made a part of this specification.

### BACKGROUND OF THE INVENTION

1. Field of the Invention

The invention relates to a calibration system, and more particularly, to a camera image calibrating system.

The invention relates to a calibration method, and more particularly, to a method of calibrating camera images.

2. Description of Related Art

In order to reduce occurrences of traffic accidents, various transport monitoring devices such as the lane departure warning system (LDWS) and the vehicle system with bird eye view attract much attention and have been developed with great expectation. Additionally, while various transportation vehicles are travelling, the departure warning system is also capable of assisting the driver to better control the transportation vehicle, so as to prevent occurrences of accidents.

On the other hand, in order to maintain the precision of warning function, the manufacturing calibration for various departure warning systems is vital. Generally speaking, the lane departure warning system in the current market performs calibration through a positioning device having feature points (such as, the checkerboard or the calibration board having feature points). However, since the camera image resolution utilized in the current driving departure warning system is not high, errors are easily generated in a manner that calibrating the angle of the camera capturing direction through capturing the feature points, such that it is difficult to achieve precise warning effect. Moreover, misjudgment can be occurred if the errors exist, which causes the accident and irreparable regret. Furthermore, in the actual application, if the camera is touched by the user inadvertently or due to other external forces being offset or even fallen off, it can only be returned to the calibration site again, which requires to spend a lot of manpower, time and money. Also, if the camera faces toward the light source (such as the sunlight or the streetlight) due to the tilt of the transportation vehicle or other environmental factors, the warning effect can be easily affected because the image has been overexposed or blurred. Moreover, if the transportation vehicle travels under the bumpy condition, the driving departure warning system can be easily affected by the bumpy condition and occurs misjudgment, since the camera and the internal image transformation matrix of the common driving departure warning system are fixed during the calibration inside the factory which can not be dynamically adjusted. Hence, how to effectively calibrate the camera image on the transportation vehicle has become one of the current issues to be addressed in the pertinent field.

### SUMMARY OF THE INVENTION

The invention is directed to a camera image calibrating system and a method of calibrating camera images, which are applicable to a transportation vehicle.

An embodiment of the invention provides a camera image calibrating system applicable to the transportation vehicle, which includes at least one image capturing unit, a plurality of direction sensing units and a processing unit. The image capturing unit is disposed on transportation vehicle according to a height, and is configured to preview an image. The direction sensing units are respectively disposed on the transportation vehicle and the image capturing unit, and are configured to obtain a vehicle directional angle of the transportation vehicle and an image capturing directional angle of the image capturing unit. The processing unit is configured to calculate an image transformation relationship and cause the image to comply with an image preset condition according to the image transformation relationship, in which the processing unit determines an offset angle of the image capturing unit disposed in the transportation vehicle according to the image, the vehicle directional angle and the image capturing directional angle, and the processing unit further calculates the image transformation relationship according to the height, the offset angle and the image, in a static calibration procedure.

In an embodiment of the invention, when the image changes and is not complying with the image preset condition, the camera image calibrating system performs a dynamic calibration procedure to vary the image transformation relationship or the image capturing directional angle of the image capturing unit, and further performs the static calibration procedure until the image complies with the image preset condition.

In an embodiment of the invention, when the image complies with the image preset condition, the image accurately responds to a moving direction of the transportation vehicle relative to an environment that the transportation vehicle is currently located in.

In an embodiment of the invention, when a level of the transportation vehicle being wobbled or tilted exceeds a threshold value, the camera image calibrating system adjusts the image transformation relationship until the image complies with the image preset condition, according to a directional relationship between the image capturing directional angle and the vehicle directional angle.

In an embodiment of the invention, the image capturing directional angle faces toward the front of the transportation vehicle, and the directional relationship is a difference between pitch angles of the transportation vehicle and the image capturing directional angle.

In an embodiment of the invention, the at least one image capturing unit is a plurality of image capturing units respectively disposed on different locations of the transportation vehicle, each of the image capturing units captures a corresponding image with a corresponding image capturing directional angle and the image capturing directional angles are different from each other. The camera image calibrating system respectively transforms the images to a plurality of plan views according to the image transformation relationships, and the camera image calibrating system splices the plan views into a bird eye view.

In an embodiment of the invention, the image capturing directional angles at least cover a pitch direction, a yaw direction and roll direction of the transportation vehicle.

In an embodiment of the invention, the camera image calibrating system further includes at least one adjusting holder, in which when the image becomes blur, the camera image calibrating system adjusts the image capturing directional angle of the image capturing unit through the adjusting holder, until the image complies with the image preset condition.

In an embodiment of the invention, the image capturing directional angle faces toward the front of the transportation vehicle, and the adjusting holder adjusts a pitch angle of the image capturing unit.

In an embodiment of the invention, the at least one image capturing unit is a plurality of image capturing units, the at least one adjusting holder is a plurality of adjusting holders, in which the image capturing units are respectively disposed on different locations of the transportation vehicle, each of the image capturing units captures a corresponding image with a corresponding image capturing directional angle and the image capturing directional angles are different from each other. The camera image calibrating system respectively transforms the images to a plurality of plan views according to the image transformation relationships, and the camera image calibrating system splices the plan views into a bird eye view.

In an embodiment of the invention, the image capturing directional angles at least cover a pitch direction, a yaw direction and roll direction of the transportation vehicle, and the adjusting holders respectively adjust at least one of a pitch angle, a yaw angle and a roll angle of the corresponding image capturing units.

An embodiment of the invention provides a method of calibrating camera images applicable to a transportation vehicle, which includes a static calibration procedure. The static calibration procedure includes: employing at least one image capturing unit to preview an image, in which the image capturing unit is disposed on the transportation vehicle according to a height; employing a plurality of direction sensing units respectively disposed on the transportation vehicle and the image capturing unit to obtain a vehicle directional angle of the transportation vehicle and an image capturing directional angle of the image capturing unit; employing a processing unit to calculate an image transformation relationship and transform the image to a planar image according to the image transformation relationship, so as to cause the planar image to comply with an image preset condition, in which the processing unit determines an offset angle of the image capturing unit disposed in the transportation vehicle according to the image, the vehicle directional angle and the image capturing directional angle, and the processing unit further calculates the image transformation relationship according to the height, the offset angle and the image, in a static calibration procedure.

In an embodiment of the invention, the method of calibrating the camera image further includes a dynamic calibration procedure, in which when the image changes and is not complying with the image preset condition, the camera image calibrating system performs the dynamic calibration procedure to vary the image transformation relationship or the image capturing directional angle of the image capturing unit, and further performs the static calibration procedure until the image complies with the image preset condition.

In an embodiment of the invention, the method of calibrating the camera image further includes: when a level of the transportation vehicle being wobbled or tilted exceeds a threshold value, adjusting the image transformation relationship until the image complies with the image preset condition according to a directional relationship between the image capturing directional angle and the vehicle directional angle.

In an embodiment of the invention, the at least one image capturing unit is a plurality of image capturing units respectively disposed on different locations of the transportation vehicle, each of the image capturing units captures a corresponding image with a corresponding image capturing directional angle and the image capturing directional angles are different from each other, in which the method of calibrating the camera image further includes: respectively transforming the images to a plurality of plan views according to the image transformation relationships, and splicing the plan views into a bird eye view.

In an embodiment of the invention, the method of calibrating the camera image further includes: when the image becomes blur, adjusting the image capturing directional angle of the image capturing unit through at least one adjusting holder, until the image complies with the image preset condition.

In an embodiment of the invention, the at least one image capturing unit is a plurality of image capturing units, the at least one adjusting holder is a plurality of adjusting holders, in which the image capturing units are respectively disposed on different locations of the transportation vehicle, each of the image capturing units captures a corresponding image with a corresponding image capturing directional angle and the image capturing directional angles are different from each other. The method of calibrating the camera image further includes: respectively transforming the images to a plurality of plan views according to the image transformation relationships; and splicing the plan views into a bird eye view.

Based on the above description, in the embodiments of the invention, the camera image calibrating system after being static calibrated is capable of performing the static calibration procedure once more through varying one of the image transformation relationship and the image capturing directional angle of the image capturing unit, thereby maintaining the image complying with the image preset condition to serve as the reference for determining a travel state of the transportation vehicle. Moreover, in the embodiments of the invention, the method of calibrating the camera image is capable of dynamically maintaining the image through varying one of the image transformation relationship and the image capturing directional angle of the image capturing unit, thereby causing the image to comply with the image preset condition to serve as the reference for determining a travel state of the transportation vehicle.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a side-view schematic diagram illustrating a camera image calibrating system disposed on a transportation vehicle according to an embodiment of the invention.

FIG. 1B is a top-view schematic diagram illustrating a camera image calibrating system disposed on a transportation vehicle according to an embodiment of the invention.

FIG. 2A is a schematic diagram illustrating an optical path when an image capturing camera captures a real object.

FIG. 2B is a schematic diagram illustrating a projection path of the image capturing camera depicted in FIG. 1.

FIG. 3 is a schematic diagram illustrating the transportation vehicle equipped with the camera image calibrating system depicted in FIG. 1 that is located on a slope.

FIG. 4 is a schematic diagram illustrating an adjusting holder and the image capturing unit depicted in FIG. 1.

FIG. 5 is a schematic diagram illustrating a camera image calibrating system according to another embodiment of the invention.

FIG. 6A is a flowchart diagram illustrating a static calibration procedure in a method of calibrating camera images according to yet another embodiment of the invention.

FIG. 6B is a flowchart diagram illustrating a dynamic calibration procedure in a method of calibrating camera images according to yet another embodiment of the invention.

### DESCRIPTION OF THE EMBODIMENTS

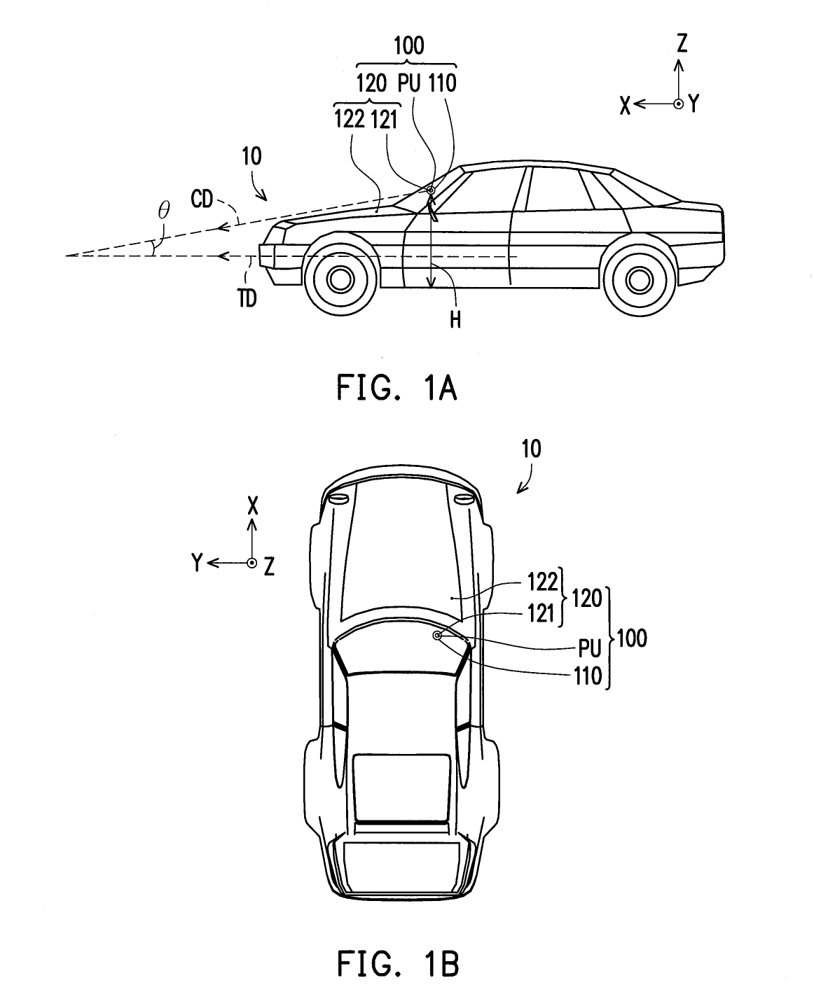

FIG. 1A is a side-view schematic diagram illustrating a camera image calibrating system disposed on a transportation vehicle according to an embodiment of the invention. FIG. 1B is a top-view schematic diagram illustrating a camera image calibrating system disposed on a transportation vehicle according to an embodiment of the invention. Referring to FIG. 1A and FIG. 1B, in the embodiment, the camera image calibrating system 100 applicable to a transportation vehicle 10 may include at least one image capturing unit 110, a plurality of direction sensing units 120 and a processing unit PU. In the embodiment, the direction sensing units 120 may include two direction sensing units 121 and 122, for instance. The direction sensing units 120 may include devices applicable to detect directions, such as a three-axis gyroscope, an accelerator and a magnetometer. The image capturing unit 110 may be the device applicable to capture images, such as an image capturing camera. Moreover, in the embodiment, the transportation vehicle 10 is taking a car vehicle as an example, although the invention is not limited thereto. The image capturing unit 110 may be disposed on the transportation vehicle 10. The direction sensing units 121 and 122 may be respectively disposed on the image capturing unit 110 and the transportation vehicle 10.

In the embodiment, the image capturing unit 110 is required to calibrate first, in order for the image captured by the image capturing unit 110 to serve as the reference for determining whether being offset while the transportation vehicle 10 is traveling. To be specific, in the embodiment, the image capturing unit 110 is disposed on the transportation vehicle 10 according to a height H, and is configured to preview an image. In the embodiment, the height H may be a predetermined value, and may be the height between the image capturing unit 110 and the bottom of the transportation vehicle 10 (such as the vehicle floor depicted in FIG. 1A), for instance, although the invention is not limited thereto. The direction sensing units 120 may be respectively disposed on the transportation vehicle 10 and the image capturing unit 110, and are configured to obtain a vehicle directional angle TD of the transportation vehicle 10 and an image capturing directional angle CD of the image capturing unit 110. The processing unit PU may be configured to calculate an image transformation relationship and cause the image to comply with an image preset condition according to the image transformation relationship, in which the image transformation relationship and the image preset condition will be elaborated hereinafter.

To be specific, in the embodiment, in a static calibration procedure, the processing unit PU may determine an offset angle θ of the image capturing unit 110 disposed in the transportation vehicle 10 according to the image, the vehicle directional angle TD and the image capturing directional angle CD (as shown in FIG. 1), and the processing unit PU may further calculate the image transformation relationship according to the height H, the offset angle θ and the image. For example, in the embodiment, the processing unit PU may adjust the offset angle θ of the image capturing unit 110 through other driving mechanisms (that will be elaborated hereinafter). Moreover, in the embodiment, the image transformation relationship may be an image transformation matrix, for instance. After calculating the image transformation matrix, the processing unit PU may store such matrix in a memory unit (not shown) for subsequent use. The detail descriptions related to the image transformation relationship will also be elaborated hereinafter.

For example, in the embodiment, the image preset condition may be the condition that causes the image to accurately respond to the world coordinate in real time (that is, an environment that the transportation vehicle 10 is currently located in), and may be the capturing coverage of the image, the size of the image or other related image parameters. To be more specific, in the embodiment, when the image capturing unit 110 is disposed on the transportation vehicle 10 with a predetermined height H and a particular direction, and the captured image complies with the image preset condition, the image is capable of accurately responding to a moving direction of the transportation vehicle 10 relative to the environment that the transportation vehicle 10 is currently located in. Therefore, when the image complies with the image preset condition, the processing unit PU may determine the moving state of the transportation vehicle 10 relative to the environment that the transportation vehicle 10 is currently located in according to the image, such that may be applied to the lane departure warning system (LDWS) or other image warning systems for transportation vehicles, for instance.

The camera image calibrating system 100 of the embodiment in the static calibration procedure may calculate and store the image transformation relationship through the processing unit PU according to the predetermined height H, the offset angle θ and the image, so that the image capturing directional angle CD and the height H of each image capturing unit 110 may not be calibrated in a labour/manual manner to comply with the image preset condition, and the complicated calibration process may not be performed at the particular calibration site, and thus the time and the cost required for calibration may be reduced and concurrently the fine accuracy may also be possessed.

In other words, after the static calibration procedure, the camera image calibrating system 100 is capable of transforming the features in the image captured by the image capturing unit 110 (such as lane lines) to the world coordinates in real time through the image transformation relationship. In the embodiment, since the image capturing unit 110 is mounted on the transportation vehicle 10, when the features in the image captured by the image capturing unit 110 are offset (such as the lane lines appear to be offset or skewed), it is indicated that the travel direction of the transportation vehicle 10 relative to the ground is offset, and the driver may be further warned by the lane departure warning system (LDWS) or other warning systems, for instance.

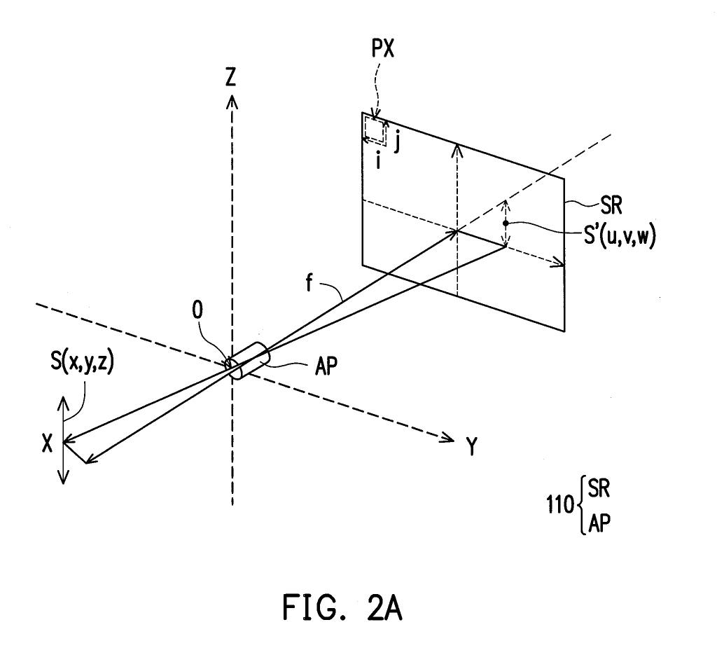

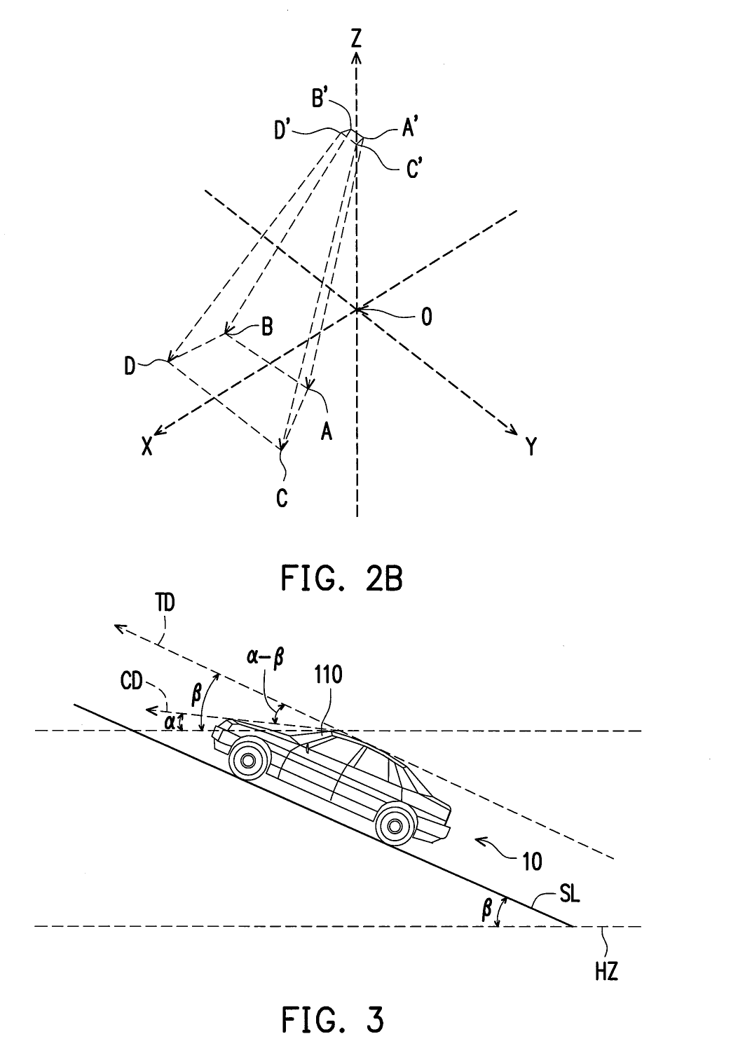

To be specific, in the embodiment, the image transformation relationship may be the relationship between the image capturing directional angle CD and an image captured by the image capturing unit 110, for instance. For example, FIG. 2A is a schematic diagram illustrating an optical path when an image capturing camera captures a real object. Referring to FIG. 1A through FIG. 2A, in the embodiment, an image sensing element SR and an image capturing aperture AP included in the image capturing unit 110 are shown in FIG. 2A, in which when the image capturing unit 110 faces toward the image of an real object S to be captured along a X-axis direction, the image of the real object S may be formed on the image sensing element SR through the image capturing aperture AP (as shown in the image S′) according to the pin-hole camera model. In other words, a transformation matrix exists between the real object S and the image S′, namely, an offset level of the car vehicle relative to the lane in the real world may be obtained from the feature variation of the image S′ (such as the direction variation of the lane line) through transforming the transformation matrix.

For example, if the image coordinates of the image S′ on the image sensing element SR are [u, v, w] and the world coordinates of the real object S in real time that the image S′ responds are [x, y, z], the coordinates [u, v, w] may be transformed to the coordinates [x, y, z] through the following formula:

$$[ \begin{matrix}x \\ y \\ z\end{matrix} ] = R \cdot [ \begin{matrix}u \\ v \\ w\end{matrix} ] = R ( {θ}_{Roll} ) \cdot R ( {θ}_{pitch} ) \cdot R ( {θ}_{Yaw} ) \cdot [ \begin{matrix}u \\ v \\ w\end{matrix} ]$$

where R(θ_{Roll}), R(θ_{Pitch}), R(θ_{Yaw}) indicate rotation matrixes of a roll angle, a pitch angle and a yaw angle, respectively.

To be more specific, the image capturing unit 110 relative to the location, height, angle of a horizontal plane (that is, the X-Y plane) may be set in advance according to actual requirement. For example, FIG. 2B is a schematic diagram illustrating a projection path of the image capturing camera depicted in FIG. 1. Referring to FIG. 1A through FIG. 2B, in the embodiment, the image capturing unit 110 relative to the world coordinates in real time (that is, the ambient environment) are, for instance, (0, 0, 150) (the unit is centimetre (cm), for instance) and the image sensing element SR of the image capturing unit 110 (a tetragon constituted by points A′, B′, C′ and D′) may correspond to a tetragon constituted by points A, B, C and D that form the capturing coverage of the image capturing unit 110 in the real world. In the embodiment, taking a complementary metal oxide semiconductor sensor (CMOS sensor) with 640×480 sensing pixels as an example, it is assumed that the coordinates of the four points A′, B′, C′ and D′ are as follow:

$${A}^{′} = [ \begin{matrix}\frac{- 640}{2} \cdot i \\ \frac{480}{2} \cdot j \\ f\end{matrix} ] ; {B}^{′} = [ \begin{matrix}\frac{- 640}{2} \cdot i \\ \frac{- 480}{2} \cdot j \\ f\end{matrix} ] ;$$

$${C}^{′} = [ \begin{matrix}\frac{640}{2} \cdot i \\ \frac{480}{2} \cdot j \\ f\end{matrix} ] ; {D}^{′} = [ \begin{matrix}\frac{640}{2} \cdot i \\ \frac{- 480}{2} \cdot j \\ f\end{matrix} ] ,$$

where i indicates the length of each of the pixels PX on the image sensing element SR along the Y-axis direction, j indicates the length of each of the pixels PX on the image sensing element SR along the Z-axis direction, and f is the focal length of the image capturing unit 110. Since the initial location and the image capturing directional angle CD of the image capturing unit 110 may be determined in advance according to actual requirement, the information regarding the pitch angles, the roll angles and the yaw angles of the image capturing unit 110 and the transportation vehicle 10 may be obtained from the direction sensing units 120. Hence, the coordinate points A′, B′, C′ and D′ on the image sensing unit SR may be transformed to the world coordinates A, B, C and D in real time through the pin-hole camera model and the afore-described rotation matrixes R(θ_{Roll}), R(θ_{Pitch}), R(θ_{Yaw}), and it may be accurately calibrated without the particular calibration board or calibration site.

On the other hand, in order for the world coordinates in real time (relative to the horizontal plane) to transform to the environment that the transportation vehicle 10 is currently located in (the non-horizontal road surface, such as hillsides) once more, the world coordinates A, B, C and D in real time inferred from the coordinate points A′, B′, C′ and D′ on the image sensing element SR may be projected onto a required plane once more. It is assumed that the coordinate of point A′ corresponding to the world coordinate in real time (that is, point A) as follows:

$$A = [ \begin{matrix}1 \\ 1 \\ 149\end{matrix} ] ,$$

since the coordinate point O of the image capturing unit 110 is located at (0, 0, 150) in the real world, a vector A̅O̅ is (1, 1, −1). After the vector A̅O̅ is deduced, the vector A̅O̅ may be employed to infer the coordinates of point A′ projecting onto each of the planes in the world coordinate in real time. For example, it is assumed that point A is located on the X-Y plane (that is, Z=0) of the world coordinate in real time, and according to the following formula:

$$\{ \begin{matrix}Z = 0 \\ \frac{X - 0}{1} = \frac{Y - 0}{1} = \frac{Z - 150}{- 1}\end{matrix} \}$$

the coordinates of point A projecting onto the X-Y plane may be inferred as (150, 150, 0). Similarly, the image captured by the image capturing unit 110 may be employed to transform the other points B, C and D to point B′, C′ and D′ firstly, and then to transform onto the plane to be projected (such as the plane that Z=0), although the invention is not limited to projecting onto the plane that Z=0. In other embodiments, it may also be projected onto a plane of the slope having an inclination (which may be obtained from the direction sensing units 120) where the transportation vehicle 10 is located, for instance, thereby responding to the relationship between the transportation vehicle 10 and the road surface to serve as the reference for determining whether being offset. In other words, employing the image capturing unit 110 is capable of transforming the world coordinates in real time (that is, relative to the coordinates of the horizontal plane) to the environment that the transportation vehicle is currently located in (such as, the road surface that the car travels on, being tilted or bumpy without being parallel to the horizontal plane) through the calculations described above, and is capable of performing instant calibration and becoming closer to the actual requirement.

To be more specific, the image transformation relationship (that is, the matrix M) between the coordinates [u, v, w] on the image sensing element SR and the world coordinates [x, y, z] in real time may be presented by a two-dimensional homogeneous equation as follows:

$$λ \cdot [ \begin{matrix}u \\ v \\ w\end{matrix} ] = M \cdot [ \begin{matrix}x \\ y \\ z\end{matrix} ] = [ \begin{matrix}{m}_{11} & {m}_{12} & {m}_{13} \\ {m}_{21} & {m}_{22} & {m}_{23} \\ {m}_{31} & {m}_{32} & 1\end{matrix} ] [ \begin{matrix}u \\ v \\ w\end{matrix} ]$$

since there are eight variables in the afore-described matrix M, only four sets of data (such as points A′, B′, C′ and D′ corresponding to point A, B, C and D) are at least required to infer the image transformation relationship (that is, the matrix M) through the least square error algorithm. After the image transformation relationship (that is, the matrix M) is inferred, the camera image calibrating system 100 may store the image transformation relationship (that is, the matrix M), and when the transportation vehicle 10 is traveling, the look-up table manner may be employed to inquire the matrix M, so as to transform the features in the image (such as the lane lines) to the world coordinates in real time to serve as the reference for determining whether the transportation vehicle 10 travels offsetly. Hence, a significant amount of time for calculating the matrix M may be further reduced, and it is facilitated to distinguish images accurately and instantly. It should be noted that, the afore-described matrix M is taking the 3×3 matrix as an example, although the invention is not limited thereto.

Since the height H, the location and the image capturing directional angle CD of the image capturing unit 110 disposed on the transportation vehicle may all be set in advance, the world coordinates [x, y, z] of the feature points in real time (relative to the horizontal plane) may be inferred from the coordinates [u, v, w] of the feature points (such as, the reflective points on the lane lines) in the image captured by the image sensing element SR of the image capturing unit 110 through the afore-described pin-hole camera model, in the static calibration procedure. After at least four sets of paired coordinates [u, v, w] and [x, y, z] are obtained, the image transformation relationship (that is, the matrix M) between the two coordinates may be inferred by employing the least square error algorithm described above, and the image transformation relationship may be further stored as the look-up table in the memory unit, in which the memory unit may be a flash memory or other memories, although the invention is not limited thereto. In other words, the image capturing unit 110 is capable of performing the static calibration procedure automatically without being at the particular calibration site. By this way, a significant amount of time and manpower may be reduced and it is capable of calibrating accurately. Hence, the camera image calibrating system 100 is capable of accurately determining whether the offset occurs when the transportation vehicle 10 is traveling, through the variation of the feature points (such as the lane lines) in the image captured by the image capturing unit 110.

However, when the image changes and is not complying with the image preset condition, such as when the transportation vehicle 10 is traveling on a bumpy or tilted road surface that affects the image which fails to serve as the reference for determining whether the moving direction of the transportation vehicle is offset, the camera image calibrating system 100 may perform a dynamic calibration procedure to vary the image transformation relationship (that is, the matrix M) or the image capturing directional angle CD of the image capturing unit 110, and may further perform the afore-described static calibration procedure until the image complies with the image preset condition. In the embodiment, when the afore-described image complies with the image preset condition, the image captured by the image capturing unit 110 may accurately respond to the moving direction of the transportation vehicle 10 relative to the environment that the transportation vehicle 10 is currently located in (such as the road).

To be specific, in the dynamic calibration procedure, when a level of the transportation vehicle 10 being wobbled or tilted exceeds a threshold value, the camera image calibrating system 100 may adjust the image transformation relationship (that is, the matrix M) until the image complies with the image preset condition (namely, until the image is sufficient to serve as the basis for determining whether the transportation vehicle 10 travels offsetly), according to a directional relationship between the image capturing directional angle CD and the vehicle directional angle TD.

For example, FIG. 3 is a schematic diagram illustrating the transportation vehicle equipped with the camera image calibrating system depicted in FIG. 1 that is located on a slope. Referring to FIG. 1 and FIG. 3, in the embodiment, the transportation vehicle 10 (such as the car vehicle) travels on a slope SL, an included angle between the slope SL and a horizontal line HZ is β, and the image capturing directional angle CD faces toward the front of the transportation vehicle 10, in which the vehicle directional angle TD of the transportation vehicle 10 also includes a β angle with the horizontal line HZ, and the image capturing directional angle CD of the image capturing unit 110 includes an α angle with the horizontal line HZ. Since the transportation vehicle 10 and the image capturing unit 110 respectively have the direction sensing units 121 and 122 (as shown in FIG. 1), the information of the α and β angles may be measured, in which an (α-β) angle between the α and β angles is the difference between the pitch angles of the image capturing unit 110 and the slope SL, namely, the directional relationship described above. According to the (α-β) angle, when the level of the road surface being bumpy or the inclination of the slope SL being varied fiercely exceeds the predetermined threshold value, the camera image calibrating system 100 is capable of detecting such variation of the pitch angle and executing the afore-described dynamic calibration procedure to re-calculate and re-adjust the image transformation relationship (that is, adjusting the matrix M that is calculated in the static calibration procedure), so that the affected image is re-adjusted and re-transformed so as to obtain a correct perspective matrix (that is, a new matrix M), thereby adapting to the impact generated by the road surface being bumpy or the inclination of the slope SL being varied fiercely on the image.

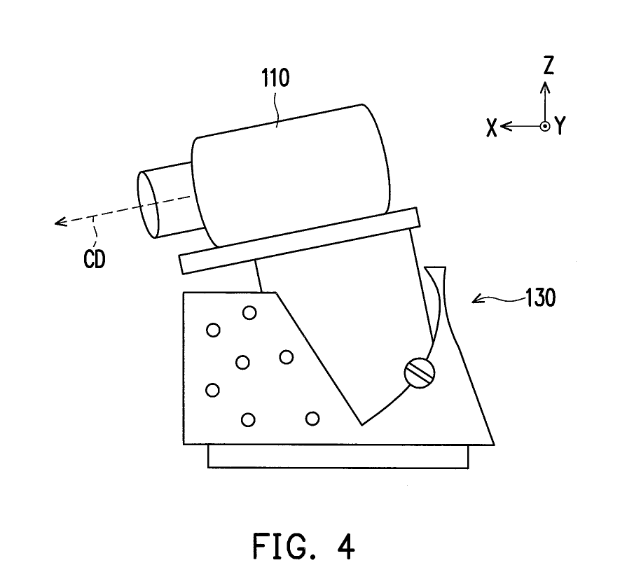

On the other hand, FIG. 4 is a schematic diagram illustrating an adjusting holder and the image capturing unit depicted in FIG. 1. Referring to FIG. 1 and FIG. 4, the afore-described camera image calibrating system 100 may further include at least one adjusting holder 130, in which when the image becomes blur, the camera image calibrating system 100 is capable of adjusting the image capturing directional angle CD of the image capturing unit 110 through the adjusting holder 130, until the image complies with the image preset condition. For example, in some occasions that the influence of light is great (such as the places where the exposure situation is serious), the image captured by the image capturing unit 110 may also be affected at this moment, so that the serious exposure or blur situation may occur, and the accuracy of distinguishing may be affected. Under such circumstances, the image capturing unit 110 may adjust the image capturing directional angle CD through the adjusting holder 130 (in the embodiment, the image capturing directional angle CD faces toward the front of the transportation vehicle 10, and the adjusting holder 130 may adjust a pitch angle of the image capturing unit, for instance, although the invention is not limited thereto), and the afore-described static calibration procedure is re-performed according to the new image capturing directional angle CD, such that the image is able to recover the accuracy of distinguishing.

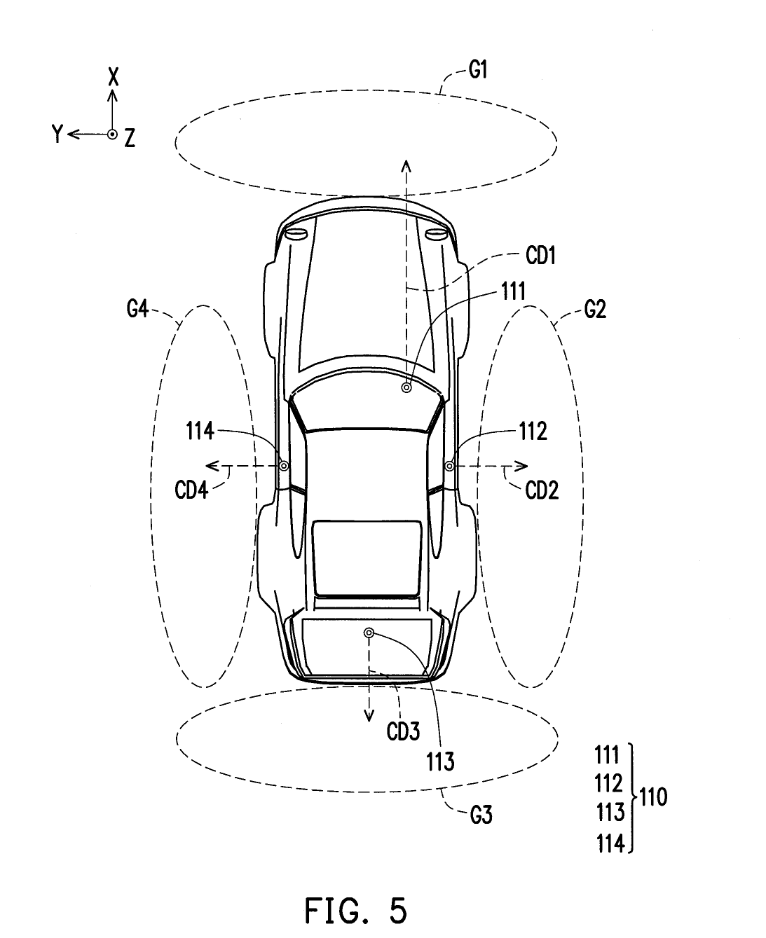

FIG. 5 is a schematic diagram illustrating a camera image calibrating system according to another embodiment of the invention. Referring to FIG. 1 through FIG. 5, the camera image calibrating system depicted in FIG. 5 is similar to the camera image calibrating system 100 depicted in FIG. 1, expect that the at least one image capturing unit 110 in the camera image calibrating system 200 of the embodiment is a plurality of image capturing units 111, 112, 113 and 114, and the at least one adjusting holder 130 is a plurality of adjusting holders (not shown in FIG. 5). The image capturing units 111 to 114 are respectively disposed on different locations of the transportation vehicle 10, such as being disposed on four sides (that is, front, back, left and right sides) of the transportation vehicle 10. Each of the image capturing units 111 through 114 captures a corresponding image with a corresponding image capturing directional angle CD1, CD2, CD3, CD4 in all directions, in which the image capturing directional angles CD1, CD2, CD3, CD4 are different from each other. The camera image calibrating system 200 may respectively transform the images to a plurality of plan views according to the image transformation relationships inferred from the images (that are captured with the image capturing directional angles CD1, CD2, CD3, CD4), and the camera image calibrating system 200 may splice the plan views into a bird eye view. In other words, each of the image capturing units 111 through 114 may respectively obtain the images of regions G1 through G4 and splice them together into the bird eye view, for instance, to further serve as the reference for determining whether the transportation vehicle 10 travels offsetly or other variations in all directions.

To be more specific, the image capturing directional angles CD1, CD2, CD3 and CD4 described above may at least cover the pitch direction, the yaw direction and the roll direction of the transportation vehicle 10. In this way, the camera image calibrating system 200 may further determine whether the variation (such as the pitch direction, the yaw direction and the roll direction) of the transportation vehicle 10 occurs in all directions. When the level of the road being bumpy or tilted varies fiercely, the camera image calibrating system 200 is capable of detecting such variation and dynamically adjusting the image transformation relationships (that is, the perspective matrixes of the image capturing units 111, 112, 113 and 114).

For example, even the transportation vehicle 10 (such as the car vehicle), the transportation vehicle 10 is in the state of being tilted toward the right side due to the component issue or the tilted road (that is, the transportation vehicle 10 has the roll angle), and when such tilted state exceeds a predetermined threshold value, the images captured by the image capturing units 111, 112, 113 and 114 may be modified, so that the determination of the car vehicle being offset is no longer accurate. At this moment, the camera image calibrating system 200 may employ the direction sensing units (not shown in FIG. 5) of the image capturing units 111, 112, 113 and 114 to determine the pitch direction, the yaw direction and the roll direction of each of the image capturing units 111, 112, 113 and 114, and may selectively vary the image transformation relationships or adjust the image capturing directional angles CD1-CD4 through each of the adjusting holders 130, and may further perform the static calibration procedure, thereby maintaining the accuracy of the images for determining whether the offset occurs when the transportation vehicle 10 is traveling.

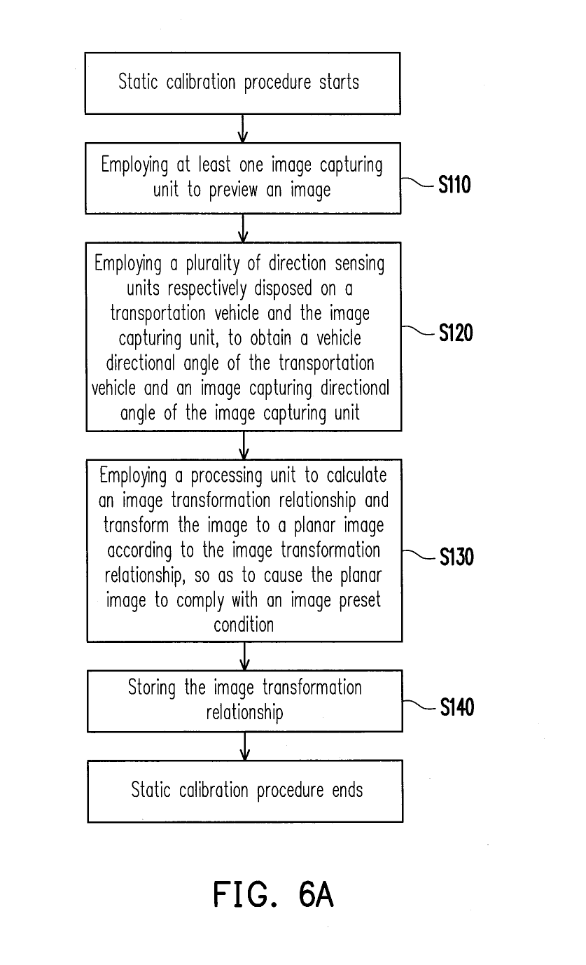

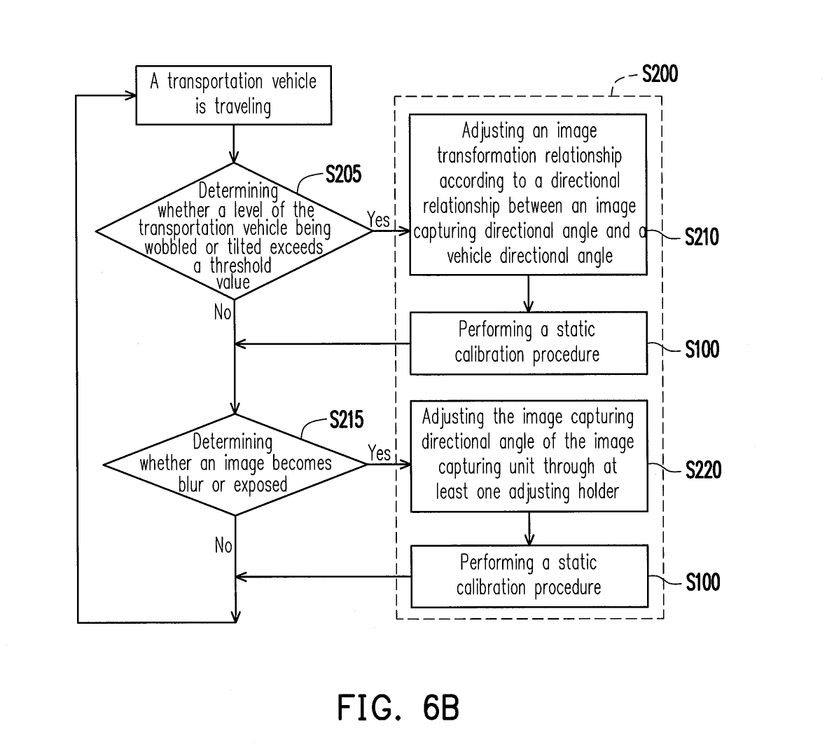

FIG. 6A is a flowchart diagram illustrating a static calibration procedure in a method of calibrating camera images according to yet another embodiment of the invention. FIG. 6B is a flowchart diagram illustrating a dynamic calibration procedure in a method of calibrating camera images according to yet another embodiment of the invention. Referring to FIG. 1 through FIG. 6B, in the embodiment, the method of calibrating the camera image may be implemented through the camera image calibrating systems 100, 200 depicted in FIG. 1 and FIG. 5, for instance. The method of calibrating the camera image applicable to the transportation vehicle 10 includes the static calibration procedure (step S100) and the dynamic calibration procedure (step S200), in which the static calibration procedure may include: employing at least one image capturing unit 110 to preview an image, wherein the image capturing unit 110 is disposed on the transportation vehicle 10 according to a height H (step S110); employing a plurality of direction sensing units 120 respectively disposed on the transportation vehicle 10 and the image capturing unit 110, to obtain a vehicle directional angle TD of the transportation vehicle 10 and an image capturing directional angle CD of the image capturing unit 110 (step S120); employing a processing unit PU to calculate an image transformation relationship (such as the matrix M described above) and transform the image to a planar image according to the image transformation relationship, so as to cause the planar image to comply with an image preset condition (step S130), wherein the processing unit PU may determine an offset angle θ of the image capturing unit 110 disposed in the transportation vehicle 10 according to the image, the vehicle directional angle TD and the image capturing directional angle CD, and the processing unit PU further calculates the image transformation relationship according to the height H, the offset angle θ and the image, in the static calibration procedure. The related components and the detailed descriptions may be referred to the embodiments depicted in FIG. 1 through FIG. 6B, and thus a relevant description thereof is omitted herein.

For example, in step S110 of the embodiment, at least one image capturing unit 110 is employed to preview an image, and the location of the image capturing unit 110 disposed in the transportation vehicle 10, the image capturing directional angle CD of the image capturing unit 110 to be placed, the size of the aperture, the image sensing resolution of the image capturing unit 110, the focal length and the height H of the image capturing unit 110 to be placed in the transportation vehicle 10 may be determined according to actual requirement, although the invention is not limited thereto. Moreover, in step S130, the number of the image capturing directional angle CD, the image capturing unit 110 and the image transformation relationship may be singular or plural, in which when the number thereof is plural, the method of calibrating the camera image may further include: respectively transforming the images to a plurality of plan views according to the image transformation relationships; and splicing the plan views into a bird eye view, as shown in the embodiments depicted in FIG. 1 and FIG. 5, and thus a relevant description thereof is omitted herein.

Additionally, in the embodiment, the static calibration procedure may also further include: storing the image transformation relationship (step S140). Thus, the time for calculating the image transformation relationship several times may be reduced through the look-up table manner, and until the image is required to be re-calibrated due to the influence of external factors, the subsequent dynamic calibration procedure is further executed to calibrate.

The dynamic calibration procedure includes that when the image changes and is not complying with the image preset condition (such as when the transportation vehicle 10 is traveling on a bumpy or tilted road surface that affects the image which fails to serve as the reference for determining whether the moving direction of the transportation vehicle 10 is offset), one of the image transformation relationship and the image capturing directional angle CD is varied and the static calibration procedure is further performed, until the image complies with the image preset condition. To be specific, the dynamic calibration procedure in the afore-described method of calibrating the camera image may further include: determining whether a level of the transportation vehicle 10 being wobbled or tilted exceeds a threshold value (step S205), in which when the level of the transportation vehicle 10 being wobbled or tilted exceeds the threshold value, adjusting the image transformation relationship according to a directional relationship between the image capturing directional angle CD and the vehicle directional angle TD (step S210), until the image complies with the image preset condition; and determining whether the image becomes blur or exposed (step S215), in which when the image becomes blur, adjusting the image capturing directional angle CD of the image capturing unit 110 through at least one adjusting holder 130 (step S220), until the image complies with the image preset condition. It should be noted that the sequence and the flow of the steps described above are only configured to illustrate the embodiment, although the invention is not limited thereto. For instance, in other embodiments, step S215 and step S220 may also be implemented firstly and step S205 and step S210 may then be implemented in the dynamic calibration procedure, which may also maintain the similar effects. The related components and the detailed descriptions may be referred to the embodiments depicted in FIG. 1 through FIG. 5, and thus a relevant description thereof is omitted herein.

Based on the above description, the camera image calibrating system and the method of calibrating the camera image in the embodiments of the invention are capable of achieving the static calibration procedure without being used at the particular calibration site, which can reduce manpower, time and cost, and can also maintain the fine accuracy. Moreover, the camera image calibrating system and the method of calibrating the camera image in the embodiments of the invention are capable of performing the dynamic calibration procedure according to the requirement at any time, even though the transportation vehicle is located in the bumpy or tilted environment, or even when the image capturing directional angle of the image capturing unit is touched by the user inadvertently and varied, the camera image calibrating system can still be calibrated automatically and instantly to recover the accuracy. Additionally, in the embodiments of the invention, the direction sensors of the camera image calibrating system are low priced and able to provide instant camera image calibration, and can be further applied to the camera calibration on various transportation vehicles.

Based on the above description, the optical touch system shown in the embodiments of the invention can detect whether the object floats above the base plane or touches the base plane through the image detecting module detects whether the portion of the detecting light obstructed by the object conforms with the predetermined conditions. Moreover, the optical touch system can further detect the two-dimensional coordinate of the object along the direction parallel to the base plane under the circumstance of the plurality of image detecting modules being disposed and the plurality of detecting lights being provided.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A camera image calibrating system, applicable to a transportation vehicle, comprising:
at least one image capturing unit, disposed on the transportation vehicle according to a height, and configured to preview an image;
a plurality of direction sensing units, respectively disposed on the transportation vehicle and the at least one image capturing unit, and configured to obtain a vehicle directional angle of the transportation vehicle and an image capturing directional angle of the at least one image capturing unit; and
a processing unit, configured to calculate an image transformation relationship and cause the image to comply with an image preset condition according to the image transformation relationship,
wherein the processing unit determines an offset angle of the at least one image capturing unit disposed in the transportation vehicle according to the image, the vehicle directional angle and the image capturing directional angle, and the processing unit further calculates the image transformation relationship according to the height, the offset angle and the image, in a static calibration procedure.

2. The camera image calibrating system according to claim 1, wherein when the image complies with the image preset condition, the image accurately responds to a travel state of the transportation vehicle relative to an environment that the transportation vehicle is currently located in.

3. The camera image calibrating system according to claim 1, wherein when the image changes and is not complying with the image preset condition, the camera image calibrating system performs a dynamic calibration procedure to vary the image transformation relationship or the image capturing directional angle of the at least one image capturing unit, and further performs the static calibration procedure until the image complies with the image preset condition.

4. The camera image calibrating system according to claim 1, wherein when a level of the transportation vehicle being wobbled or tilted exceeds a threshold value, the camera image calibrating system adjusts the image transformation relationship until the image complies with the image preset condition, according to a directional relationship between the image capturing directional angle and the vehicle directional angle.

5. The camera image calibrating system according to claim 4, wherein the image capturing directional angle faces toward the front of the transportation vehicle, and the directional relationship is a difference between pitch angles of the transportation vehicle and the image capturing directional angle.

6. The camera image calibrating system according to claim 4, wherein the at least one image capturing unit is a plurality of image capturing units respectively disposed on different locations of the transportation vehicle, each of the image capturing units captures a corresponding image with a corresponding image capturing directional angle and the image capturing directional angles are different from each other, and the camera image calibrating system respectively transforms the images to a plurality of plan views according to the image transformation relationships, and the camera image calibrating system splices the plan views into a bird eye view.

7. The camera image calibrating system according to claim 6, wherein the image capturing directional angles at least cover a pitch direction, a yaw direction and roll direction of the transportation vehicle.

8. The camera image calibrating system according to claim 1, further comprising at least one adjusting holder, wherein when the image becomes blur, the camera image calibrating system adjusts the image capturing directional angle of the at least one image capturing unit through the at least one adjusting holder, until the image complies with the image preset condition.

9. The camera image calibrating system according to claim 8, wherein the image capturing directional angle faces toward the front of the transportation vehicle, and the at least one adjusting holder adjusts a pitch angle of the at least one image capturing unit.

10. The camera image calibrating system according to claim 8, wherein the at least one image capturing unit is a plurality of image capturing units, the at least one adjusting holder is a plurality of adjusting holders, the image capturing units are respectively disposed on different locations of the transportation vehicle, each of the image capturing units captures a corresponding image with a corresponding image capturing directional angle and the image capturing directional angles are different from each other, and the camera image calibrating system respectively transforms the images to a plurality of plan views according to the image transformation relationships, and the camera image calibrating system splices the plan views into a bird eye view.

11. The camera image calibrating system according to claim 10, wherein the image capturing directional angles at least cover a pitch direction, a yaw direction and roll direction of the transportation vehicle, and the adjusting holders respectively adjust at least one of a pitch angle, a yaw angle and a roll angle of the corresponding image capturing units.

12. A method of calibrating camera images, applicable to a transportation vehicle, comprising:
a static calibration procedure, comprising:
employing at least one image capturing unit to preview an image, wherein the at least one image capturing unit is disposed on the transportation vehicle according to a height;
employing a plurality of direction sensing units respectively disposed on the transportation vehicle and the at least one image capturing unit, to obtain a vehicle directional angle of the transportation vehicle and an image capturing directional angle of the at least one image capturing unit; and
employing a processing unit to calculate an image transformation relationship and transform the image to a planar image according to the image transformation relationship, so as to cause the planar image to comply with an image preset condition,
wherein the processing unit determines an offset angle of the at least one image capturing unit disposed in the transportation vehicle according to the image, the vehicle directional angle and the image capturing directional angle, and the processing unit further calculates the image transformation relationship according to the height, the offset angle and the image, in the static calibration procedure.

13. The method of calibrating the camera image according to claim 12, wherein when the image complies with the image preset condition, the image accurately responds to a travel state of the transportation vehicle relative to an environment that the transportation vehicle is currently located in.

14. The method of calibrating the camera image according to claim 12, further comprising a dynamic calibration procedure, wherein when the image changes and is not complying with the image preset condition, the camera image calibrating system performs the dynamic calibration procedure to vary the image transformation relationship or the image capturing directional angle of the at least one image capturing unit, and further performs the static calibration procedure until the image complies with the image preset condition.

15. The method of calibrating the camera image according to claim 14, further comprising:
when a level of the transportation vehicle being wobbled or tilted exceeds a threshold value, adjusting the image transformation relationship until the image complies with the image preset condition according to a directional relationship between the image capturing directional angle and the vehicle directional angle.

16. The method of calibrating the camera image according to claim 15, wherein the image capturing directional angle faces toward the front of the transportation vehicle, and the directional relationship is a difference between pitch angles of the transportation vehicle and the image capturing directional angle.

17. The method of calibrating the camera image according to claim 15, wherein the at least one image capturing unit is a plurality of image capturing units respectively disposed on different locations of the transportation vehicle, each of the image capturing units captures a corresponding image with a corresponding image capturing directional angle and the image capturing directional angles are different from each other, wherein the method of calibrating the camera image further comprises:
respectively transforming the images to a plurality of plan views according to the image transformation relationships; and
splicing the plan views into a bird eye view.

18. The method of calibrating the camera image according to claim 17, wherein the image capturing directional angles at least cover a pitch direction, a yaw direction and roll direction of the transportation vehicle.

19. The method of calibrating the camera image according to claim 14, further comprising:
when the image becomes blur, adjusting the image capturing directional angle of the at least one image capturing unit through at least one adjusting holder, until the image complies with the image preset condition.

20. The method of calibrating the camera image according to claim 19, wherein the image capturing directional angle faces toward the front of the transportation vehicle, and the at least one adjusting holder adjusts a pitch angle of the at least one image capturing unit.

21. The method of calibrating the camera image according to claim 19, wherein the at least one image capturing unit is a plurality of image capturing units, the at least one adjusting holder is a plurality of adjusting holders, the image capturing units are respectively disposed on different locations of the transportation vehicle, each of the image capturing units captures a corresponding image with a corresponding image capturing directional angle and the image capturing directional angles are different from each other, wherein the method of calibrating the camera image further comprises:
respectively transforming the images to a plurality of plan views according to the image transformation relationships; and
splicing the plan views into a bird eye view.

22. The method of calibrating the camera image according to claim 21, wherein the image capturing directional angles at least cover a pitch direction, a yaw direction and roll direction of the transportation vehicle, and the adjusting holders respectively adjust at least one of a pitch angle, a yaw angle and a roll angle of the corresponding image capturing units.
